(19) United States
(12) Patent Application Publication
(10) Pub. No.: US 2017/0124672 A1
(43) Pub. Date: May 4, 2017

(54) System and Method for Location-Based Provision of Legal Services

(71) Applicant: Antonio Jason Velez, San Clemente, CA (US)

(72) Inventor: Antonio Jason Velez, San Clemente, CA (US)

(21) Appl. No.: 15/339,086

(22) Filed: Oct. 31, 2016

Related U.S. Application Data
(60) Provisional application No. 62/249,156, filed on Oct. 30, 2015.

(51) Int. Cl. G06Q 50/18; G06Q 30/02; H04W 4/02; G06Q 30/06

(52) U.S. Cl. CPC G06Q 50/18; G06Q 30/0623; G06Q 30/0282; H04W 4/02

(57) ABSTRACT

A system and method of using location-based information to facilitate real-time communication between customers and attorneys.

### CROSS-REFERENCE TO RELATED APPLICATIONS

This application claims the benefit to a provisional patent application as stated in the ADS.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The present disclosure is in the technical field of location-based services. More particularly, the present disclosure relates to location-based provision of legal services.

Conventional methods of entering into an attorney-client contract have not changed for many decades; typically, the process of entering into an attorney-client contract is protracted compared to many other contractual relationships in the twenty-first century.

Generally, people looking for attorneys are relegated to using a telephone directory or to using internet searches, which, many times contain erroneous information, are outdated, or are simply not relevant to the consumer.

The advent of the internet, networked computing, wireless radios and devices, and global positioning systems through smart-phones and smart-devices, i.e. devices that can connect to the internet, have provided a way for consumers and service providers to connect more quickly.

Location-based information provides a way for users to obtain services from service providers who are located in close proximity and who are filtered by proximity in order to more immediately meet the demands of users.

The internet and internet-connected devices have brought many conveniences to people, especially in the field of communication. Many industries fully utilize real-time communication in order to provide better products and services at lower costs. The legal industry has been slow to adopt technological changes, including real-time communications between attorney and client.

### SUMMARY OF THE DISCLOSURE

The present disclosure is a system and method to provide location-based, real-time access to legal services.

### BRIEF DESCRIPTION OF THE DRAWING

FIG. 1 is a schematic view of the system.

FIG. 2 is a schematic view of a method for the customer.

FIG. 3 is a schematic view of a method for the attorney.

FIG. 4 is a view of a software application interface with the network and attorney profile information.

FIG. 5 is a view of a software application interface showing legal form options and showing real-time communication options.

### DETAILED DESCRIPTION OF THE INVENTION

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of any appended claims and any and all equivalents thereof. Moreover, many embodiments, such as adaptations, variations, modifications, and equivalent arrangements, will be implicitly disclosed by the embodiments described herein and fall within the scope of the present invention. Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

For our purposes herein, network means wired or wireless computer network systems and software, including, but not limited to, computer servers, computers, routers, switches, and other such devices that connect to TCP/IP networks or other such networks. Such computers and computer servers comprising the usual components, including processors for processing information, memory for storing temporary information and instructions for the processor, and storage devices for storing information and instructions. Network also means system software that allow for interaction with devices which connect to TCP/IP networks, including, but not limited to, database software, software algorithms, filtering algorithms, and other methods to manipulate data, present data, add data, delete data, duplicate data, and/or record data.

For our purposes herein, location information means information related to the location of the person and/or device through global positioning satellites and radios, triangulation or other mathematical operations that allow calculation of location, wireless and/or wired networks for calculation of location, and/or other methods and ways of determining location.

For our purposes herein, real-time communication means any immediate or slightly delayed communication such as voice, VOIP, video, SMS, MMS, instant message, and any other communication means that allows for immediate or near immediate communication between two parties, whether provided through open or proprietary software and/or hardware.

It should be understood that the steps of any such processes or methods are not limited to being carried out in any particular sequence or arrangement. Indeed, the steps of the disclosed processes or methods generally may be carried out in various different sequences and arrangements while still falling within the scope of the present invention.

For our purposes herein, customer, client, service requestor, and user will be used interchangeably and reference the same party or parties. The words attorney and service provider will be used interchangeably to reference the same party or parties.

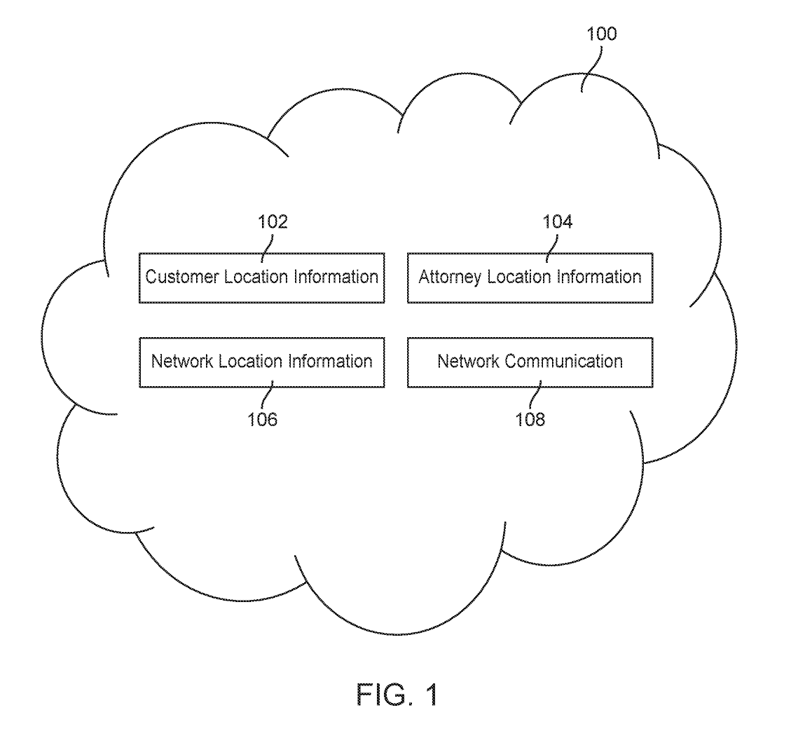

FIG. 1 shows the location-based, real-time communication system 100 comprising customer location information 102, attorney location information 104, a network configured to process location information 106, and a network configured for immediate communication between said customer and said attorney 108.

In one embodiment, not shown, the system 100, further comprising a network configured with legal forms provided to customers based on customer location information in order to meet the requirements of the jurisdiction in which the customer is located.

In another embodiment, not shown, the system 100, further comprising a payment component in the network configured to transact payments through third-party payment systems or within the network.

In another embodiment, not shown, the system 100, further comprising software configured for accessing the network via computers, mobile devices, and other devices connected to the internet or to other networks.

In another embodiment, not shown, the system 100, further comprising software or networks configured to maintain customer relationships, timekeeping, calendaring, and other functions common to the legal profession.

In one embodiment, not shown, the system 100, that includes a module configured to manage documents within the network.

In one embodiment, not shown, the system 100, that includes a module configured to provide the purchase of end-items or retail items or both.

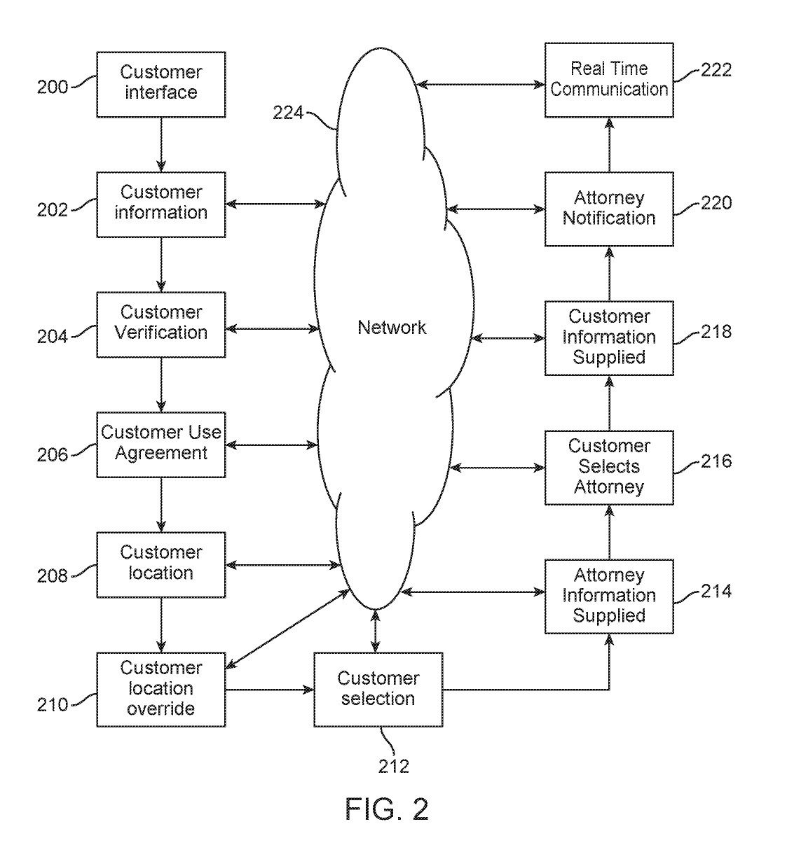

Referring to FIG. 2, a method to facilitate location-based provision of legal services through a network 224 comprising a customer interface 200 where the customer initially provides information 202 which may be verified through various third-party verification systems or through incorporated verification systems 204. Once verified, a customer must agree to a use agreement 206 and if agreed to customer location information 208 is provided to the system. Alternatively, the Customer may override Customer location data through inputting a location manually 210. Customer may then select areas of practice 212.

The customer then receives Attorney biographical information, location information, and availability information 214 from said network 224. The customer may select the Attorney based on the customer's preferences and upon other information provided to the customer 216. Upon selecting an Attorney, customer information is provided to the Attorney 218. If the Attorney is not immediately available, the network 224 notifies the Attorney 220. If the Attorney is immediately available, the network 224 facilitates real-time communication 222 between the customer and Attorney.

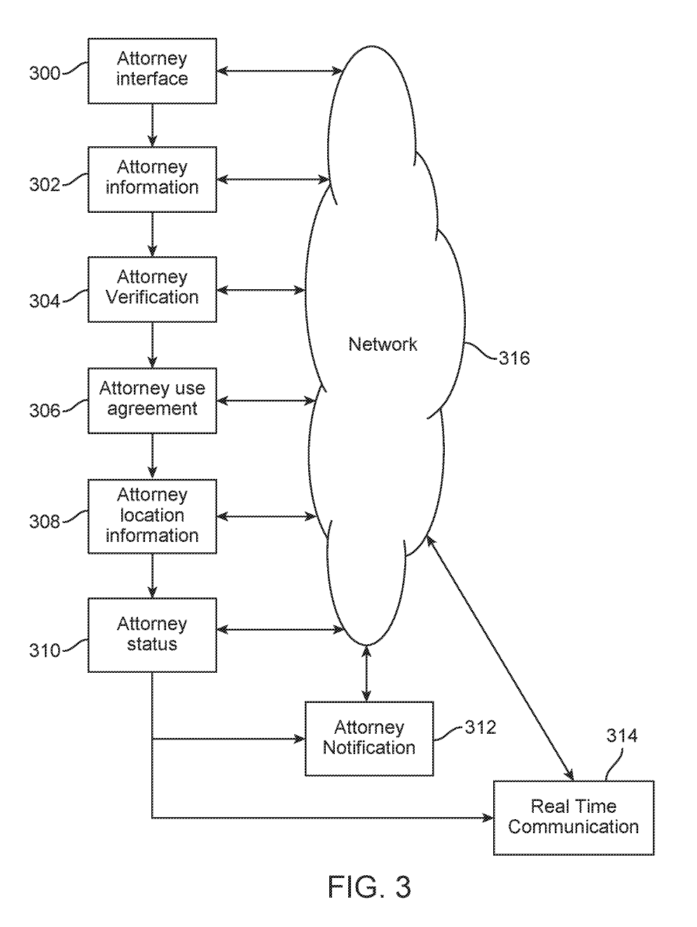

Referring to FIG. 3, a method to facilitate legal services comprising an Attorney interface 300 where the Attorney initially provides information 302 which may be verified by third-party verification networks and also verified 304 through the network 316. Once verified, an Attorney must agree to the use agreement 306. If agreed to, Attorney location information 308 is provided to the network. An Attorney must provide a status of available or unavailable 310 to the network 316. If a customer selects an Attorney, the Attorney is notified with customer information 312, and, if available, may have immediate, real-time communication 314 with customer via the network 316.

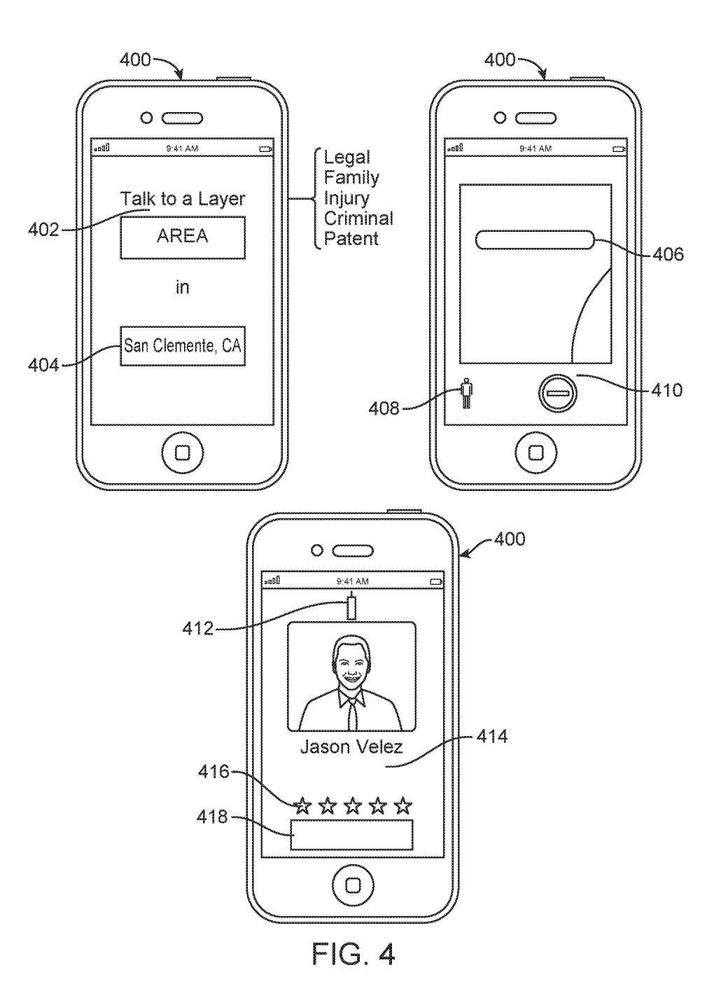

Referring to FIG. 4, in one embodiment, a mobile software application to interact with the network is shown 400 providing an area of law to select from 402 and location based filtering 404. The mobile software application 400 connecting into the network, and allowing for transfer of information to and from said network.

In one embodiment, a mobile software application to interact with the network showing location data on a map 406 with Attorney availability showing either available 408 or unavailable 410. Available 408 indicating that the Attorney is immediately available for real-time communication.

In one embodiment, a mobile software application to interact with the network showing Attorney available 412, Attorney biographical information 414, an Attorney rating and/or ranking based upon consumer feedback and/or other feedback 416, and way to begin real-time communications with Attorney 418.

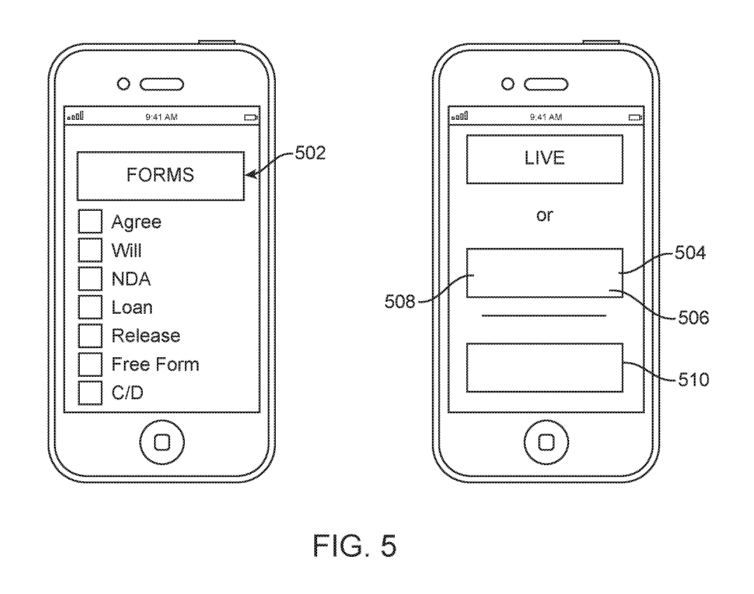

Referring to FIG. 5, a mobile software application to interact with the network showing a plurality of legal forms 502 available to Customers based on the customer's location.

In one embodiment, a software interface showing possible options for real-time communication, including chat 504, video chat 506, audio call 508, and instant messaging 510.

In one embodiment, not shown, a method of rating verified attorneys in the network by verified customers to provide verified information regarding customer experiences and attorney ratings.

In one embodiment, not shown, a method of providing legal services further comprising a method to provide a written contract between customer and selected attorney that can be electronically signed by both parties.

In another embodiment, not shown, a method of providing legal services further comprising a customer relationship management network for each Attorney which is populated with customers who have selected said Attorney.

In one embodiment, not shown, a method of purchasing consumer end-items or retail items from an online store within the network.

In another embodiment, not shown, a method of obtaining attorney information whereby various public information repositories are imported into the network to provide better Attorney ratings systems than otherwise provided. Public information repositories including, but not limited to, bar complaints, other attorney ratings, recent case information, Attorney job history, former firms, and other various data points to provide more comprehensive information.

In another embodiment, not shown, a method for obtaining customer information including a method of payment, whether through third-party payment systems or through the network where payment is made is in escrow or, if earned, transferred to Attorney for services rendered.

In another embodiment, not shown, Attorney information includes a method of payment, whether through third-party payment systems or through the network system where payments within the network are made.

What is claimed is:

1. A method for providing location-based real-time communication for legal services, the method being performed by one or more processors and comprising:
determining, for a given geographic region, position information for each of a plurality of service requestors for real-time service;
determining, for a given geographic region, position information for each of a plurality of service providers that can provide real-time service;
identifying, for a given geographic region, which service providers are immediately available and which are unavailable;
identifying, for the given geographic region, which service providers are closest to service requestors based on position information of each;
providing the service requestor with information identifying service providers that are closest to service requestors;
providing the service provider with information identifying service requestors;
providing real-time communication between service requestor and service provider.

2. The method of claim 1, wherein determining position information for each of the plurality of requestors includes receiving, over one or more networks, position information from individual requestor devices of the plurality of requestors;

3. The method of claim 1, wherein determining position information for each of the plurality of service providers includes receiving, over one or more networks, position information from individual service provider devices or physical address of the plurality of service providers;

4. The method of claim 1, wherein each of the plurality of service providers are categorized by specific areas of practice;

5. The method of claim 1, wherein service requestors may override position information provided by individual requestor devices;

6. The method of claim 1, wherein service providers and service requestors are verified through accession to contract terms;

7. The method of claim 6, wherein service providers are rated by verified service requestors;

8. The method of claim 1, wherein service providers are ranked according to information received through one or more third-party information sources;

9. The method of claim 1, wherein legal forms are provided to service requestor based on service requestor's location information;

10. The method of claim 1, wherein verified service requestor information is stored in database for the service provider;

11. The method of claim 1, wherein a network provides service requestor information, calendar information and transaction information for service provider;

12. A system comprising:
one or more networks;
one or more processors to:
determine, for a given geographical region, position information for each of a plurality of service requestors for real-time services;
determine, for a given geographical region, position information for each of a plurality of service providers that can provide real-time services;
identify service providers position information;
identify service requestors position information;
provide service requestor with relative positon information of one or more service providers;
provide real-time communication between service requestor and service provider.

13. The system of claim 12, wherein one or more processors determine position information for each of the plurality of requestors by receiving, over one or more networks, position information from individual requestor devices of the plurality of requestors;

14. The system of claim 12, wherein one or more processors determine position information for each of the plurality of service providers by receiving, over one or more networks, position information from individual service provider devices or the physical address of the plurality of service providers;

15. The system of claim 12, wherein one or more processors determine each of the plurality of service provider's specific areas of practice;

16. The system of claim 12, wherein one or more processors determine service requestors position information based on service requestor's input;

17. The system of claim 12, wherein one or more processors determine service provider ratings based on service requestor's input;

18. The system of claim 12, wherein one or more processors ranks service providers through one or more third-party information sources;

19. The system of claim 12, wherein one or more processors provides legal forms based on service requestor's location information.

20. The system of claim 12, wherein a network provides service requestor information, calendar information, and transaction information for service provider.
